(19) United States
(12) Patent Application Publication
(10) Pub. No.: US 2017/0122019 A1
(43) Pub. Date: May 4, 2017

(54) DEVICE FOR CLOSING A CLOSURE MEMBER HINGED ONTO A SUPPORT

(71) Applicant: LOCINOX, Waregem (BE)

(72) Inventor: Joseph TALPE, Heestert-Zwevegem (BE)

(73) Assignee: LOCINOX, Waregem (BE)

(21) Appl. No.: 15/294,982

(22) Filed: Oct. 17, 2016

(30) Foreign Application Priority Data
Oct. 30, 2015 (EP) 15192469.3

(51) Int. Cl. E05F 3/08; E05F 5/02; E05D 7/04

(52) U.S. Cl. CPC E05F 3/08; E05D 7/0423; E05F 5/02; E05Y 2900/00; E05Y 2900/40

(57) ABSTRACT

A closing device includes a torque storing mechanism, a first and a second actuation member which are both rotatable with respect to the supporting frame and a mechanical connector piece which is rotatable with respect to the supporting frame and configured for being mechanically fixed to the second hinge member which is fixed to the closure member. A first locking mechanism enables to lock the mechanical connector piece either to the first actuation member or to the second actuation member and a second locking mechanism enables to lock the supporting frame to the second actuation member when the connector piece is locked to the first actuation member and to the first actuation member when the connector piece is locked to the second actuation member. In this way, the closing device is suited for left and right turning closure members without requiring an extra gearing to reverse the rotation direction.

### BACKGROUND OF THE INVENTION

Field of the Invention

The present invention relates to a device for closing a closure system, in particular a door, a gate, etc. hinged on a support, which closing device comprises a torque storing mechanism for storing torque exerted onto the closure system when opening it and for restoring the torque to effect closure of the closure system, a damper mechanism for damping the closing movement of the closure system.

Background

The closure system comprises a closure member hinged by means of at least one hinge onto a support, which hinge comprises a first hinge member fixed to one of the closure member and the support and a second hinge member pivoted onto the first hinge member around a pivot axis and being fixed to the other one of the closure member and the support. Preferably, the second hinge member comprises a threaded rod portion which enables to adjust the distance between the closure member and the support. The torque storing mechanism comprises a first and a second actuation member and a spring mechanism arranged between both the actuation members. The actuation members are rotatable with respect to one another around a rotation axis, in a first mutual direction, to store said torque in said spring mechanism and in a second mutual direction, which is opposite to said first mutual direction, to restore said torque. The damper mechanism is operatively coupled to the torque storing mechanism for damping the rotation of the first actuation member with respect to the second actuation member in said second mutual direction.

Such a device is disclosed for example in EP 2 356 304 which describes a damped actuator to effect automatic closure of a closure member without slamming. The closing device disclosed in the first series of figures of this European patent is mounted in a vertical position on the support onto which the closure member is hinged. At the top it has a long rotating arm, the free extremity of which is slidably mounted on the closure member to transmit the rotation of the closure member to the torque storing mechanism and the damper mechanism and vice versa.

A drawback of such gate closers is that assembly of the gate closer onto the existing closure system is time consuming. In particular, the rotating arm has to be mounted on the hinged closure member in a specific position and the gate closing mechanism itself has to be mounted on the support in a specific position such that the rotation of the closure member is transmitted correctly to the torque storing mechanism and the damper mechanism. This specific position depends on the closure system itself and can depend on the relative position of the closure member with respect to the support, the type of hinge between the closure member and the support, etc.

A further drawback of such gate closers is that they have two openings in the top for mounting the rotating arm such that the gate closers can be used for both right turning and left turning gates. This can cause confusion during installation of the gate closer. The two mounting positions in the top are connected by a gearing to transmit the rotation to the torque storing mechanism and the damper mechanism. Due to the fact that the arm of the gate closer has to be mounted in different positions onto the gate closer for a right or for a left turning gate, the actuation of the gate closer is different for a left or a right turning gate due to the different position of the rotation axis of the arm with respect to the position of the hinge axis. Moreover, it is essential that the arm is relatively long to minimize the differences in angular rotation of the gate closers for left and right turning doors or gates.

One more drawback of such gate closers is that problems arise when the height at which the closure member is hinged onto the support has to be adjusted, for example by means of height adjustable hinges as disclosed in EP-1528202. Since the rotating arm is fixed to the closure member the gate closer needs to be repositioned on the support when repositioning the closure member with respect to the support, which requires drilling new holes in the support.

A further drawback of such gate closers is that the rotating arm can get bent after installation preventing the operation of the gate closer. This can happen due to vandalism so that the gate closer is not vandal proof.

An object of the present invention is to provide a closing device for closing a hinged closure member which does not require a relatively long rotating arm to engage onto the closure member in order to transmit the rotation of the closure member to the torque restoring and damper mechanisms and which is suited for a left and a right turning closure member without an extra gearing which causes a displacement of the rotation axis of the rotating arm.

### SUMMARY OF THE INVENTION

To this end, the device according to the present invention is characterised in that the closing device comprises a frame supporting the damper mechanism and the torque storing mechanism wherein the first and the second actuation member are rotatable around said rotation axis with respect to the supporting frame. The supporting frame is configured for being mounted on the closure system with said rotation axis oriented substantially parallel to said pivot axis. The closing device further comprises a mechanical connector piece which is rotatable with respect to the supporting frame around said rotation axis and which is configured for being mechanically fixed to said second hinge member, a first locking mechanism enabling to lock the connector piece either with respect to said first or with respect to said second actuation member of the torque storing mechanism and a second locking mechanism enabling to lock the supporting frame with respect to said second actuation member when the connector piece is locked with respect to said first actuation member and with respect to said first actuation member when the connector piece is locked with respect to said second actuation member.

Due to the fact that the supporting frame is configured to be mounted on the closure system with said rotation axis oriented substantially parallel to said pivot axis and the mechanical connector piece is configured for being mechanically fixed to the second hinge member to transmit the rotation of said second hinge member to one of said first or said second actuation member using the first locking mechanism, while the second locking mechanism locks the other one of said first or said second actuation member to the supporting frame, there is no need for the closing device to comprise a relatively long rotating arm mounted onto the closure member. Instead, a direct connection can be made with the second hinge member to transmit the rotation of said second hinge member to the torque restoring and damper mechanisms. Furthermore, the first and second locking mechanisms are interchangeable in the sense that either the first actuation member follows the rotation of the second hinge member and the second actuation member is fixed or the second actuation member follows the rotation of the second hinge member and the first actuation member is fixed. In this way the device according to the present invention is suited for a left and a right turning closure member without the need for an extra gearing.

In a preferred embodiment of the device according to the present invention, the damper mechanism is a hydraulic damper mechanism which comprises a hydraulic cylinder barrel connected to the first actuation member and rotatably mounted with respect to said supporting frame around said rotation axis, a damper shaft connected to the second actuation member and rotatably mounted with respect to said cylinder barrel around said rotation axis, a piston placed inside the cylinder barrel dividing the cylinder barrel into two compartments, a motion converting mechanism for converting a rotational motion of the damper shaft with respect to said cylinder barrel into a translational motion of the piston along said rotation axis, at least one restricted fluid passage between the two compartments and a one-way valve allowing fluid to flow between the two compartments when the first actuation member is rotating with respect to the second actuation member in said first mutual direction.

In this preferred embodiment the first locking mechanism is used to transmit the rotation of the second hinge member to either of the cylinder barrel or the damper shaft via the mechanical connector piece and the second locking mechanism is used to lock the supporting frame to the other one of the cylinder barrel or the damper shaft. Depending on the rotation of the closure system, i.e. a right or a left turning closure member, either one of the cylinder barrel or the damper shaft remains stationary with respect to the frame while the other one of the cylinder barrel or the damper shaft is rotating with the mechanical connector piece attached to the second hinge member which rotates with the closure member. For both a right or a left turning closure member the motion converting mechanism for converting a rotational motion of the damper shaft with respect to said cylinder into a translational motion of the piston along said rotation axis displaces the piston to damp the closing movement of the closure member.

In this way, the internal workings of the torque storing mechanism and the damper mechanism operate in the same manner for both left turning and right turning hinged closure members.

In a further preferred embodiment of the device according to the present invention the first locking mechanism comprises a transverse connector element provided for locking the mechanical connector piece to either one of said first or said second actuation member and in that the second locking mechanism comprises a further transverse connector element provided for locking the other one of said first or said second actuation member to said supporting frame.

Preferably the supporting frame of the closing device comprises a housing which substantially encloses the torque storing mechanism and the damper mechanism, wherein the housing comprises at least two slots for receiving said transverse connector element and for enabling the actuation member which is connected to the mechanical connector piece to rotate around said rotation axis with the transverse connector element traveling through the slot.

Both slots preferably extend at least over 150°, more preferably at least over 160° and most preferably at least over 170° of the circumference of the housing so that the closure member can rotate at least over these angles with respect to the support. Depending on the closure system, i.e. a right or a left turning closure member, either one of the slots is used for allowing the transverse connector element to connect the mechanical connector piece to the actuation member which has to be rotated upon opening and closing of the closure member. For example, in a right turning closure system the first locking mechanism will use the first slot whilst in a left turning closure system the first locking mechanism will use the second slot.

In an advantageous embodiment of the device according to the present invention the mechanical connector piece is mounted on the supporting frame using at least one roller bearing, the mechanical connector piece being preferably mounted on an extremity of the supporting frame which is preferably nearest to said hinge when the closing device is mounted on the closure system.

Due to the fact that the connector piece acts directly upon the second hinge member the device can be made very compact and forces due to the rotation of the closure system do not have to be transmitted across relatively large distances. Furthermore, the forces are transmitted directly from the mechanical connector piece to the frame of the closing device, which is mounted onto the closure system, so that a robust connection is achieved between the hinge member and the torque storing mechanism. Especially when the rotation axis of the mechanical connector piece doesn't coincide completely with the hinge axis so that frictional and/or torsional forces can be produced upon rotation of the hinge member, a robust connection is important to prevent the closing device from being damaged rather quickly.

In a further advantageous embodiment of the device according to the present invention, the mechanical connector piece comprises at least one coupling mechanism to attach the mechanical connector piece to said second hinge member. This coupling mechanism comprises a hole in the mechanical connector piece, which hole has two opposing side walls which are arranged to transmit the rotation of said second hinge member to said mechanical connector piece and vice versa. The opposing side walls of the hole in the mechanical connector piece are preferably curved so that when the mechanical connector piece rotates around said rotation axis and the second hinge member around said pivot axis, the two opposing side walls remain in contact, with no play or with a substantially constant play, with said second hinge member or with a nut screwed thereon also when said rotation axis does not coincide with said pivot axis. Alternatively, the second hinge member comprises a threaded rod portion and the coupling mechanism a nut which is provided for being screwed on said threaded rod portion, with said nut having two opposite lateral surfaces and said hole two opposing side walls which are arranged to engages said lateral surfaces to transmit the rotation of said second hinge member to said mechanical connector piece and vice versa, and with the two opposite lateral surfaces of said nut being curved so that when the mechanical connector piece rotates around said rotation axis and the second hinge member around said pivot axis, the two opposite lateral surfaces of said nut remain in contact, with no play or with a substantially constant play, with said two opposing side walls of said hole in the mechanical connector piece also when said rotation axis does not coincide with said pivot axis.

In these embodiment the difference in rotation axis between the mechanical connector piece and the second hinge member is countered by the curved sides of the nut when the pivot axis and the rotation axis do not coincide. In particular, when the pivot axis and the rotation axis do not coincide there will be both a translational and a rotational movement of the second hinge member with respect to the hole in the mechanical connector piece. The lateral surfaces of the nut or the opposing side walls of the hole in the mechanical connector piece are curved in such a way that the distance between the contact points of the side walls of said and the lateral surfaces of the second hinge member or of the nut provided thereon remains constant upon rotation of the hinge member in said hole. Therefore, there is some tolerance, for example a tolerance of up to 5 mm, in mounting the device on the closure system since the pivot axis and the rotation axis do not have to coincide.

### BRIEF DESCRIPTION OF THE DRAWINGS

Other particularities and advantages of the invention will become apparent from the following description of a particular embodiment of the closing device of the present invention. The reference numerals used in this description relate to the annexed drawings wherein:

FIG. 1 is a perspective view on a closing device according to a preferred embodiment of the present invention being mounted on a right turning closure system;

FIG. 2 is a perspective view on locking the lowermost one of the actuation members to the supporting frame of the closing device illustrated in FIG. 1;

FIG. 3 is a perspective view on locking the uppermost one of the actuation members to the mechanical connector piece and storing thereby some additional torque in the spring mechanism of the closing device illustrated in FIG. 2;

FIG. 4 is a perspective view on a closing device according to a particular embodiment of the present invention being mounted on a left turning closure system;

FIG. 5 is a perspective view on locking the uppermost one of the actuation members to the supporting frame of the closing device illustrated in FIG. 4;

FIG. 6 is a perspective view on locking the lowermost one of the actuation members to the mechanical connector piece and storing thereby some additional torque in the spring mechanism of the closing device illustrated in FIG. 5;

FIG. 7 is an enlarged perspective view of the mechanical connector piece coupled to the second hinge member of the mounted closing device on a right turning closure system;

FIG. 8 is a top-down view on the closing device as illustrated in FIG. 7;

FIG. 9 is a same top-down view as FIG. 8 but showing the closure system in its open position;

FIG. 10 is a longitudinal, cross-sectional view through the closing device mounted, as illustrated in FIG. 3, on a right turning closure system;

FIG. 11 is a longitudinal, cross-sectional view through the closing device mounted, as illustrated in FIG. 6, on a left turning closure system;

FIG. 12 is an enlarged longitudinal, cross-sectional view of the first and second locking mechanisms through the closing device for a right turning closure system as illustrated in FIG. 3;

FIG. 13 is an enlarged longitudinal, cross-sectional view of the first and second locking mechanisms through the closing device for a left turning closure system as illustrated in FIG. 6; and

FIG. 14 is an enlarged longitudinal, cross-sectional view of the damper mechanism, when the closure system is closed.

### DETAILED DESCRIPTION OF THE INVENTION

The invention generally relates to a device 1 for closing a closure system 2 which comprises a closure member 3 hinged by means of at least one hinge 4 onto a support 5, which hinge comprises a first hinge member 6 fixed to one of the closure member 3 and the support 5 and a second hinge member 7 pivoted onto the first hinge member 6 around a pivot axis 8 and being fixed to the other one of the closure member 3 and the support 5, the second hinge member 7 comprising preferably a threaded rod portion 9 which enables to adjust the distance between the closure member 3 and the support 9.

Preferably, the closure system comprises a height adjust mechanism 10 for adjusting the height of the closure member 3 with respect to the support 5 as described in EP 1 528 202.

In the embodiment illustrated in the drawings, the closing device 1 comprises a torque storing mechanism 11 and a damper mechanism 12, which torque storing mechanism 11 is arranged for storing torque when said closure member 3 is being opened and for restoring said torque to effect closure of said closure member 3, and which damper mechanism 12 is arranged for damping the closing movement of said closure member 3. The torque storing mechanism 11 comprises a first actuation member 13, a second actuation member 14 and a spring mechanism 15 arranged between both actuation members 13, 14. The actuation members 13, 14 are rotatable with respect to one another around a rotation axis 16 in a first mutual direction 17 to store said torque in said spring mechanism 15 and in a second mutual direction 18, which is opposite to said first mutual direction 17, to restore said torque. The damper mechanism 12 is operatively coupled to the torque storing mechanism 11 for damping the rotation of the first actuation member 13 with respect to the second actuation member 14 in said second mutual direction 18. The closing device 1 can thus be used to automatically close the closure member 3 of a closure system 2 without slamming.

In the embodiment illustrated in the drawings, the closing device 1 further comprises a frame 19 supporting the damper mechanism 12 and the torque storing mechanism 11, with both the first 13 and the second 14 actuation member being rotatable around said rotation axis 16 with respect to the supporting frame 19. The supporting frame 19 is configured to be mounted on the closure system 2 with said rotation axis 16 oriented substantially parallel to said pivot axis 8. The closing device 1 further comprises a mechanical connector piece 20 which is rotatable with respect to the supporting frame 19 around said rotation axis 16 and which is configured for being mechanically fixed to said second hinge member 7, a first locking mechanism 21 enabling to lock the mechanical connector piece 20 either with respect to said first actuation member 13 or with respect to said second actuation member 14 of the torque storing mechanism 11 and a second locking mechanism 22 enabling to lock the supporting frame 19 with respect to said second actuation member 14 when the connector piece 20 is locked with respect to said first actuation 13 member and with respect to said first actuation member 13 when the connector piece 20 is locked with respect to said second actuation member 14.

In this embodiment, the second hinge member 7 undergoes the same rotation with respect to the first hinge member 6 as does the closure member 3 with respect to the support 5. The mechanical connector piece 20 is configured for being mechanically fixed to the second hinge member 7 and the supporting frame 19 is configured for being mounted on the closure system 2, in particular on the support 5. Thus, the mechanical connector piece 20 rotates in the same direction with respect to the supporting frame 19 as the closure member 3 with respect to the support 5. Since the mechanical connector piece 20 can be fixed to either one of the first actuation member 13 or the second actuation member 14 using the first locking mechanism 21, this actuation member 13 or 14 also rotates in the same direction with respect to the supporting frame 19 as the closure member 3 with respect to the support 5. Furthermore, the second locking mechanism 22 can lock the other one of the first actuation member 13 or the second actuation member 14 to the supporting frame 19. Therefore, the first actuation member 13 and the second actuation member 14 rotate with respect to one another in the same direction as the closure member 3 with respect to the support 5.

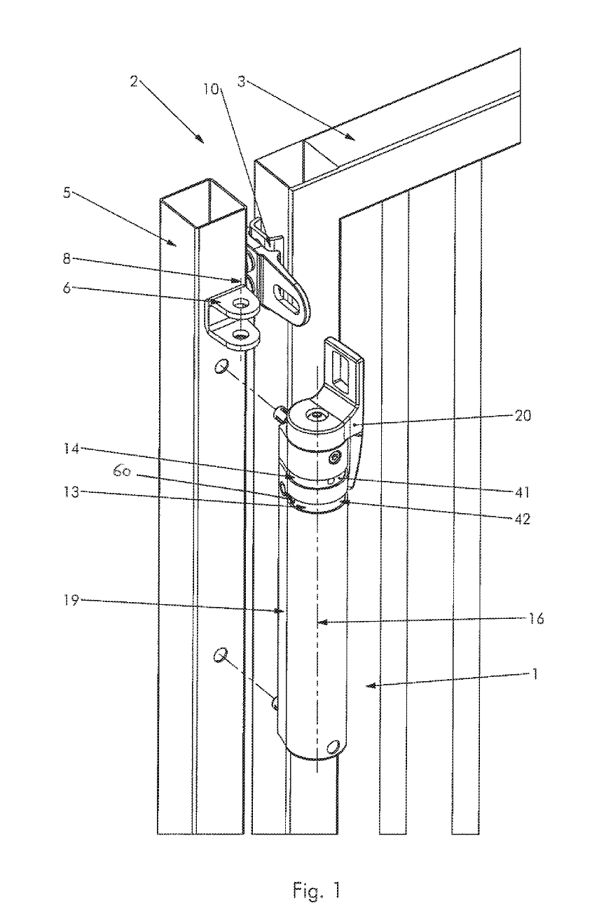

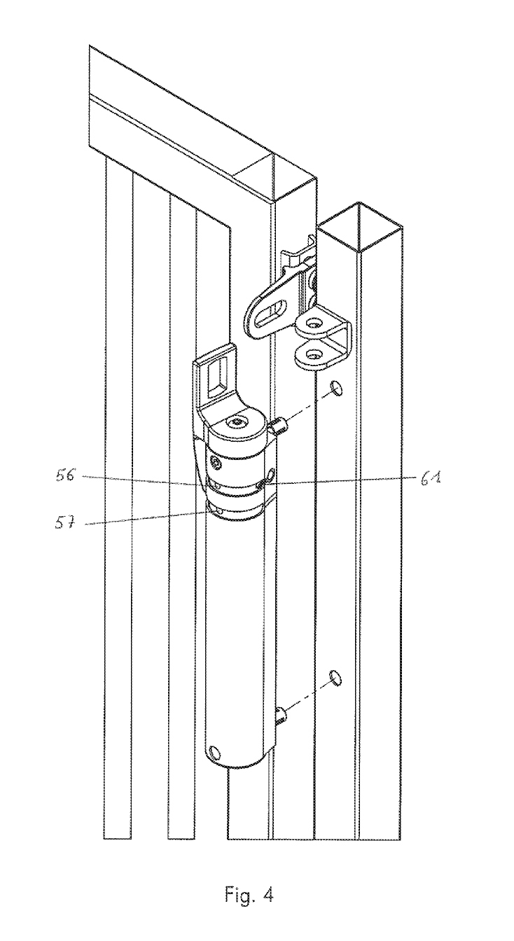

By locking the mechanical connector piece 20 to the second actuation member 14 and the first actuation member 13 to the supporting frame 19 for right turning closure systems (see FIGS. 1, 2 and 3) and by locking the mechanical connector piece 20 to the first actuation member 13 and the second actuation member 14 to the supporting frame 19 for left turning closure systems (see FIGS. 4, 5 and 6) the torque storing mechanism 11 and the damper mechanism 12 always operate in the same manner. The closing device 1 can thus be used for both for left and for right turning closure systems 2.

Due to the fact that the mechanical connector piece 20 is fixed directly to the second hinge member 7 and is mounted always in the same location directly on the supporting frame 19, the closing device 1 does not need a relatively long rotating arm to engage onto the closure member 3.

The spring mechanism 15 comprises preferably a torsion spring 23 which is coiled around the rotation axis 16 and which has one extremity attached to the first actuating member 13 and the other extremity attached to the second actuating member 14. The spring mechanism 15 has a predetermined amount of torque stored when the closure system 2 is closed as described hereafter. In this way, the spring mechanism 15 urges the first actuation member 13 to rotate with respect to the second actuation member 16 in said second mutual direction 18. Thus, when the closing device 1 is mounted on the closure system 2, the closing device 1 urges the closure system 2 to its closed position.

The damper mechanism 12 is a hydraulic damper mechanism comprising a hydraulic cylinder barrel 24 connected to the first actuation member 13, oriented substantially along said rotation axis 16 and rotatably mounted with respect to said supporting frame 19 around said rotation axis 16. It further comprises a damper shaft 25 connected to the second actuation member 14 and rotatably mounted with respect to said cylinder barrel 24 around said rotation axis 16, a piston 26 placed inside the cylinder barrel 24 dividing the cylinder barrel 24 into a first compartment 27 and a second compartment 28, and a motion converting mechanism 29 for converting a rotational motion of the damper shaft 25 with respect to said cylinder barrel 24 into a translational motion of the piston 26 along said rotation axis 16, at least one restricted fluid passage 30 between the first 27 and the second compartment 28 and at least one one-way valve 31 allowing fluid to flow from the first compartment 27 to the second compartment 28 when the first actuation member 13 is rotating with respect to the second actuation member 14 in said first mutual direction 13.

Preferably, the motion converting mechanism 29 is provided between the damper shaft 25 and the piston 26 and comprises a base element 32 which is rotatably locked to the first actuation member 13 (through the intermediary of the cylinder barrel 24) and motion converting elements which are screwed in a series onto one another and which comprise said piston 26 at one extremity of said series, said base element 32 on the other extremity of said series and one or more coupling elements 33 between said piston 26 and said base element 32. The screw threads on the different elements have alternatingly an opposite orientation (i.e. a left handed or a right handed orientation) so that a system is achieved which can be screwed telescopically in and out. The embodiment of the invention illustrated in the drawings comprises only one coupling element 33. This coupling element 33 is a rotating coupling element which is in the form of a sleeve mounted onto the damper shaft 25 so as to be substantially locked for rotation but slidable with respect to the damper shaft 25 along the rotation axis 16 of the cylinder cavity 24. The coupling element 33 can rotate about the rotation axis 16 of the damper shaft 25. In this embodiment, the damper shaft 25 comprises a slider element 34, which has a non-circular cross-section and which is fixed by means of a bolt 35 to the bottom extremity of the main part of the damper shaft 25. The rotating coupling element 33 slides over this slider element 34 upon rotation of the damper shaft 25.

Due to the telescopic system with alternatingly opposite screw threads, the stroke of the piston 26 is increased depending on the number of rotating coupling elements 33 between the base element 32 and the piston 26.

More preferably, the damper mechanism 12 further comprises a closing speed adjustment mechanism 36 in the first restricted fluid passage 30, a second restricted fluid passage 37 and a final snap adjustment mechanism 38 (enabling to adjust the free run at the end of the closing movement). The closing speed adjustment mechanism 36 comprises a needle valve for regulating the amount of flow through the restricted fluid passage 30. The final snap adjustment mechanism 38 comprises a further needle valve for regulating the amount of flow through the second restricted fluid passage 37. The second restricted fluid passage 37 is a by-pass which is only available for fluid flow between the two compartments when the piston 26 approaches the bottom of the cylinder barrel 24, i.e. when the closure system 2 is almost closed. In this way, the rotation speed of the first actuation member 13 with respect to the second actuation member 14 can be adjusted based on the amount of flow allowed through the restricted fluid passage 30. Furthermore, the speed of the final snap movement of the closure system 2 can be adjusted based on the amount of flow allowed through the second restricted fluid passage 37.

In the embodiment illustrated in the drawings, the first locking mechanism 21 comprises a transverse connector element 46, in particular a bolt, provided for locking the mechanical connector piece 20 to either one of said first actuation member 13 or said second actuation member 14, depending on the fact whether the closure system is a left or a right turning system. The second locking mechanism 22 comprises a further transverse connector element 48, in particular a further bolt, provided for locking the other one of said first actuation member 13 or said second actuation member 14 to said supporting frame 19. Furthermore, the mechanical connector piece 20 has two openings 43, 44 wherein the transverse connector element 46, one for a right turning closure system and the other one for a left turning closure system.

The supporting frame 19 further comprises two openings 49, 50 through which the further transverse connector element 48 is inserted, in particular screwed, into a further screw threaded hole (not shown) provided in each of the two actuation members. In this way, the further transverse connector element 48 of the second locking mechanism 22 cannot move with respect to the supporting frame 19 and the respective actuation member is locked with respect to the supporting frame 19.

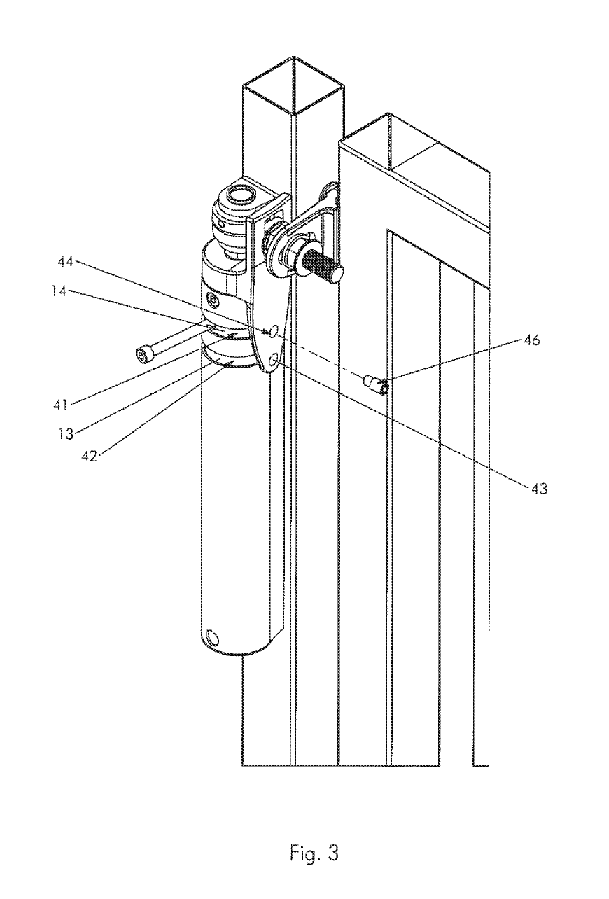

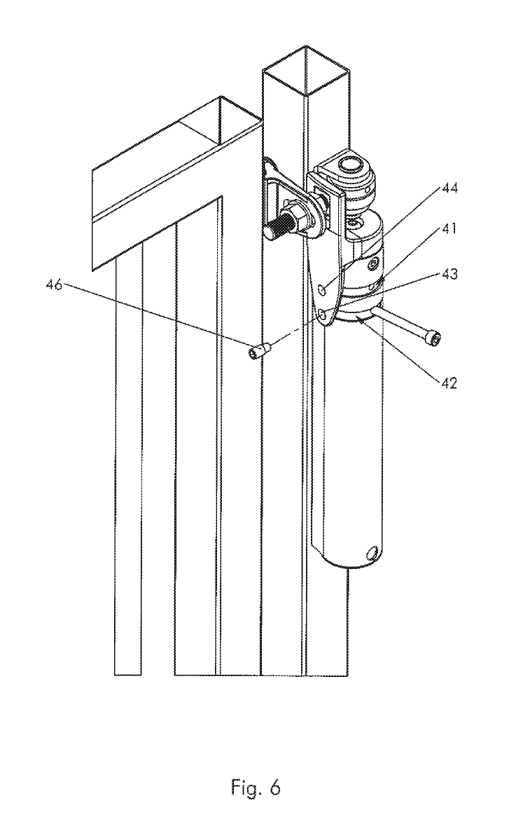

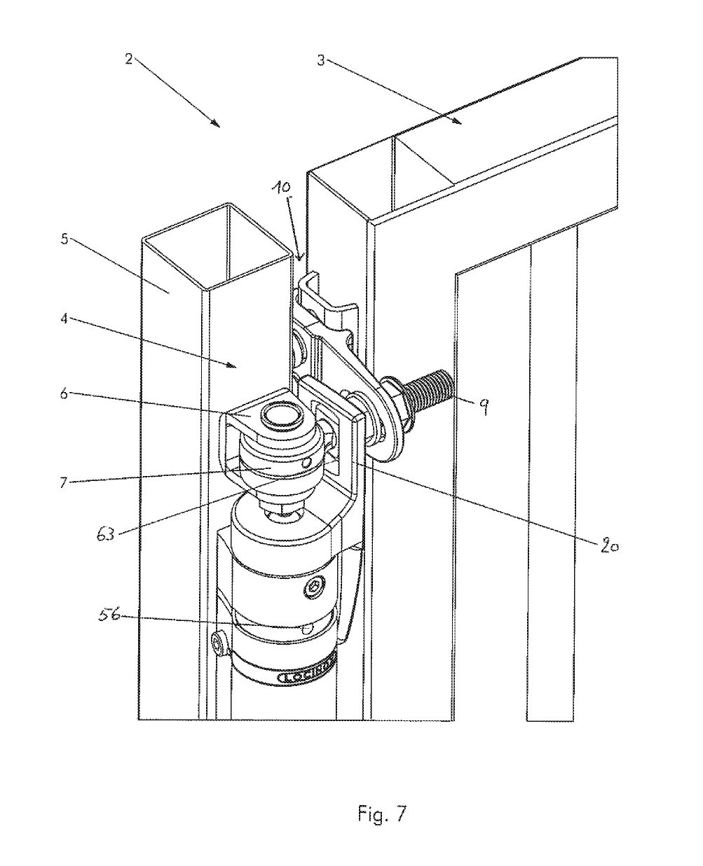

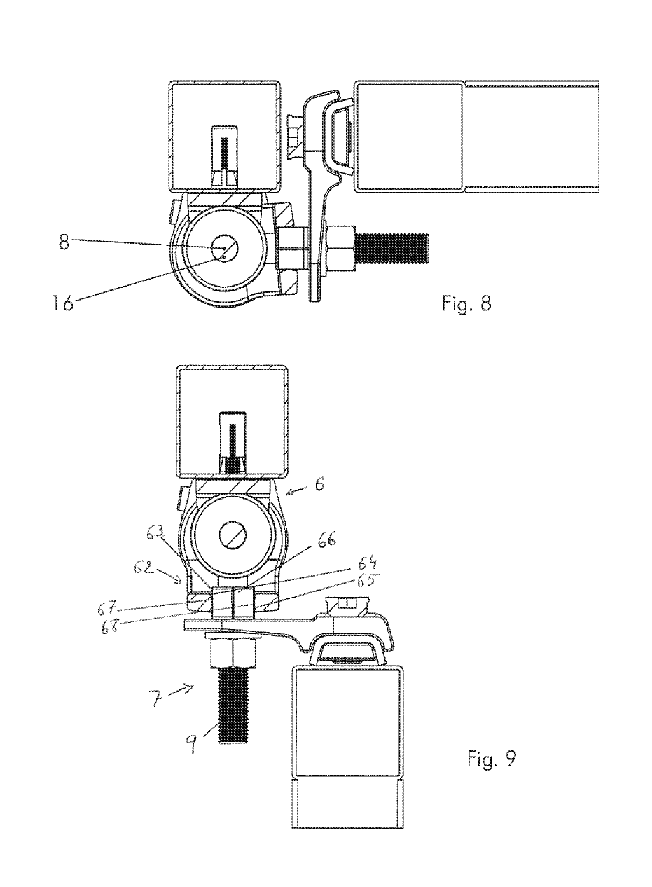

When the first actuation member 13 is locked by means of the further transverse connector element 48 through the opening 49 to the frame 19, the second actuation member 14 is to be locked, as illustrated in FIG. 3, by means of the transverse connector element 46 to the mechanical connector piece 20 and vice versa when the second actuation member 13 is locked by means of the further transverse connector element 48 through the opening 50 to the frame 19, the first actuation member 13 is to be locked, as illustrated in FIG. 6, by means of the transverse connector element 46 to the mechanical connector piece 20. In this way, the first locking mechanism 21 locks the mechanical connector piece 20 either to said first actuation member 13 or to said second actuation member 14. The second locking mechanism 22 locks the other one of the first actuation member 13 or the second actuation member 14 to the supporting frame 19. Therefore, the closing device 1 can be used for both for left and for right turning closure systems 2.

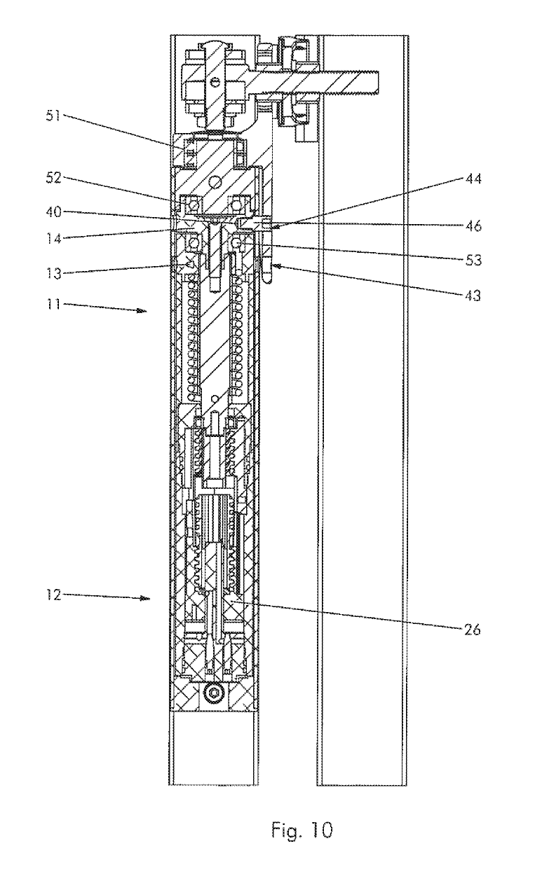

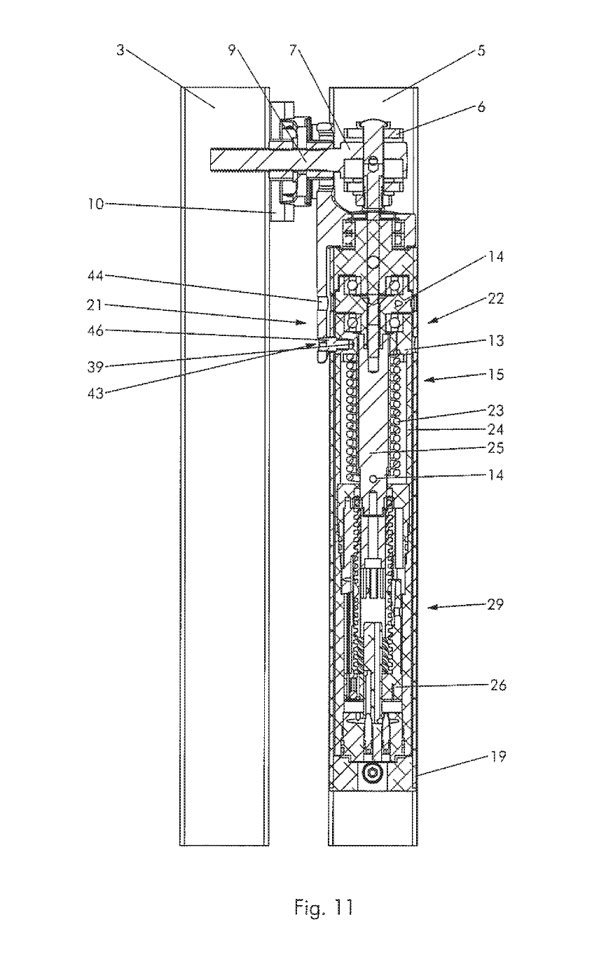

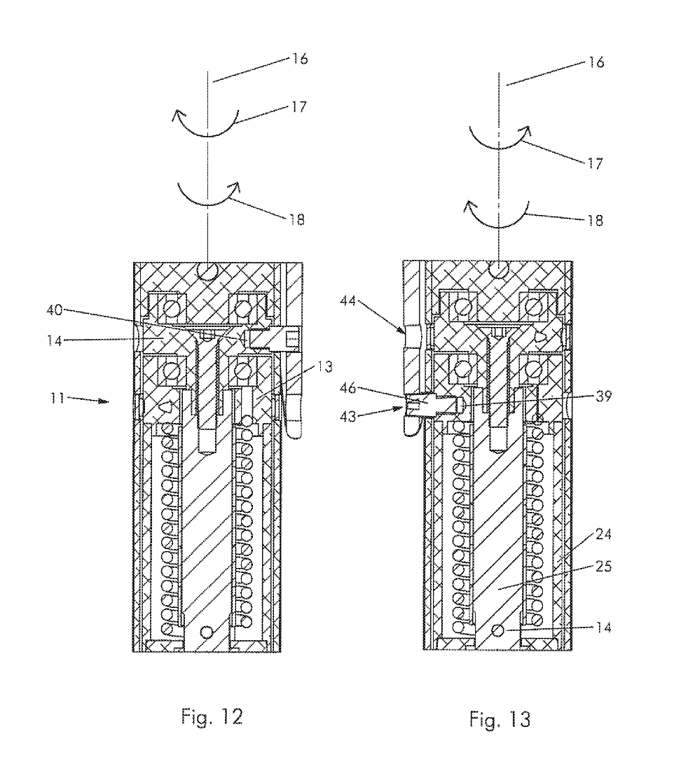

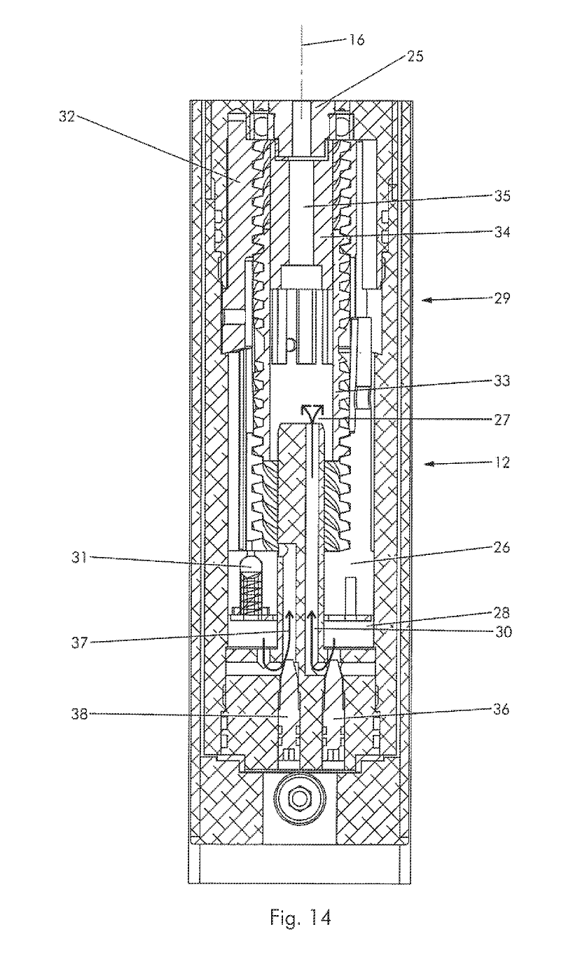

FIGS. 3 and 10 illustrate the working of the first locking mechanism 21 for a left turning closure system 2. The transverse connector element 46 is inserted through the opening 44 in the connector piece 20 in a receptor element 40, formed by a screw threaded hole, in the second actuation member 14. FIGS. 6 and 11 illustrate the working of the first locking mechanism 21 for a left turning closure system 2. The transverse connector element 46 is locked in the receptor element 39 in the first actuation member 13 through the opening 43 in the mechanical connector piece 20. In particular, the transverse connector element 46 bolt to enable the transverse connector element 46 to be screwed in the receptor elements 39, 40 which are formed by screw threaded holes in the actuation members 13 and 14.

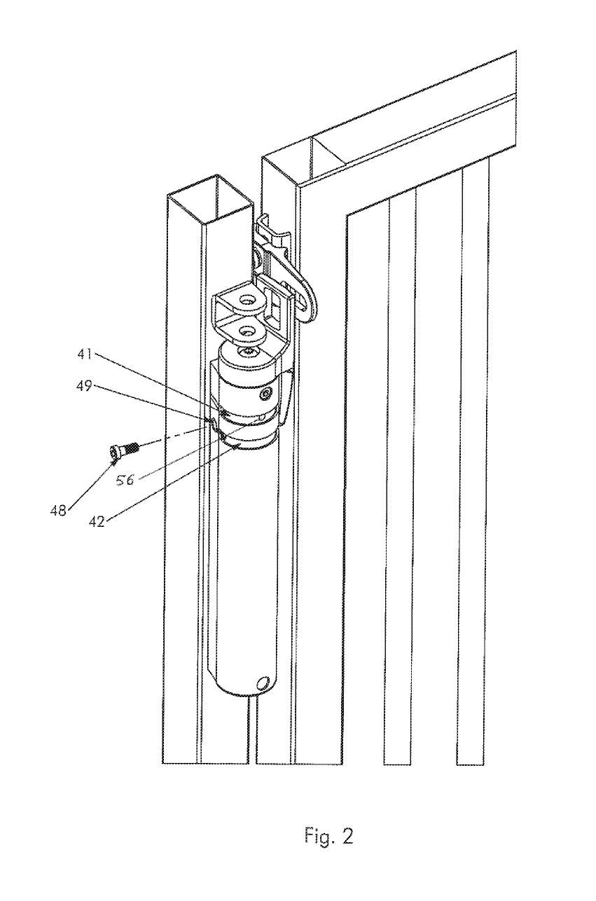

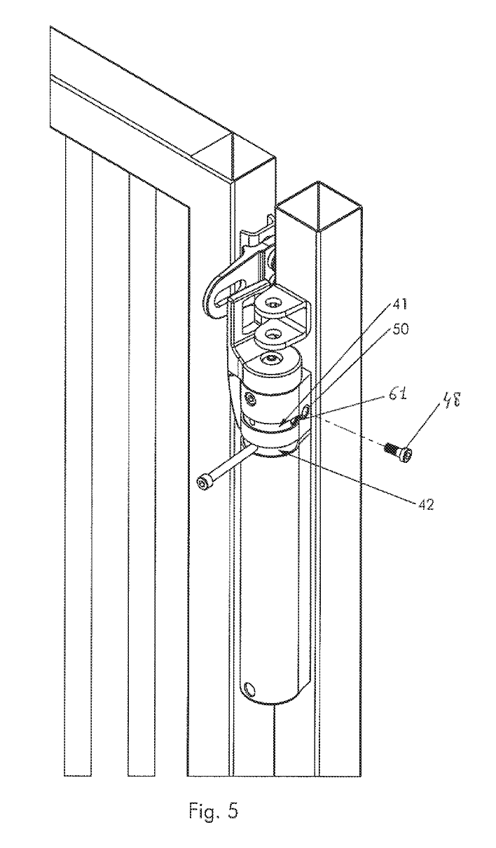

FIGS. 2 and 10 illustrate the working of the second locking mechanism 22 for a left turning closure system 2. The further transverse connector element 48, formed by a bolt, is screwed in an additional receptor element formed by a screw threaded hole (not shown) in the first actuation member 13. FIGS. 5 and 11 illustrate the working of the second locking mechanism 22 for a left turning closure system 2. The further transverse connector element 48 is locked in an additional receptor element formed by a screw threaded hole (not shown) in the second actuation member 14.

In the embodiment illustrated in the drawings, each of the first actuation member 13 and the second actuation member 14 have a further receptor element 56, 57 provided for applying a tool 58 in said further receptor element 56, 57 to enable to rotate either the first actuation member 13 or the second actuation member 14 in said first mutual direction 17. In this way, it is possible to align the receptor element 39 with the opening 44 in the mechanical connector piece 20 to enable to inserting the transverse connector element 46 in the first actuation member 13. Similarly, it is possible to align the receptor element 40 with the opening 43 in the mechanical connector piece 20 to enable to insert the transverse connector element 46 in the second actuation member 14. In the preferred embodiment illustrated in the drawings, the two actuation members 13 and 14 are indeed enabled to rotate too far compared to the closed position of the closure member so that, when the closure member 3 would not be aligned in its closed position correctly with the support 5, it is still hold by the pressure of the spring mechanism 15 in its closed position.

In the embodiment illustrated in the drawings, the supporting frame 19 comprises a housing 59 which substantially encloses the torque storing mechanism 11 and the damper mechanism 12. The housing 59 comprises at least two slots 41, 42 provided for the operation of the first locking mechanism 21 and the second locking mechanism 22. In this way, the torque storing mechanism 11 and the damper mechanism 12 can be substantially enclosed in the housing 59.

Preferably, both slots 41, 42 extend at least over 150°, preferably at least over 160° and more preferably at least over 170° of the circumference of the housing 59. In particular, the two slots 41, 42 can also be formed by one larger opening in the housing that gives access to the first 13 and the second actuation member 14. Such a larger opening also extends at least over 150°, preferably at least over 160° and more preferably at least over 170° of the circumference of the housing 59.

Due to the fact that the slots 41 and 42 has to enable the rotation of the connector element 48 around the rotation axis 16, the mechanical connector piece 20 can thus rotate at least over 150°, preferably at least over 160° and more preferably at least over 170° of the circumference of the housing 59. Therefore, when the closing device 1 is mounted on the closure system 2, the closure member 3 can rotate over at least over 150°, preferably at least over 160° and more preferably at least over 170° with respect to the support 5.

In the preferred embodiment illustrated in the drawings, the closing device 1 comprises three roller bearings 51, 52, 53. The mechanical connector piece 20 is mounted directly on the supporting frame 19 in line with the rotation axis 16 using at least one roller bearing 51. The first actuation member 13 is mounted on the supporting frame 19 using at least one roller bearing 52. The second actuation member 14 is mounted on the first actuation member 13 using at least one roller bearing 53. Furthermore, the mechanical connector piece 20 is mounted on the extremity of the supporting frame 19 closest to the hinge 4 when the closing device 1 is mounted on the closure system 2. In this way, the forces generated by closing or opening the closure system 2 are transmitted from the mechanical connector piece 20 directly to the supporting frame 19 mounted on the closure system 2 without having to transmit the forces through the damper shaft 25 or the second actuation member 14 and the cylinder barrel 24 or the first actuation member 13 in case the mechanical connector piece 20 would for example by rotatably mounted on the damper shaft 25 instead of directly onto the frame 19.

In the embodiment of the closing device 1 illustrated in the drawings, each of the first actuation member 13 and the second actuation member 14 are provided with a small pin 60, 61 that is inserted in each of the first actuation member 13 and the second actuation member 14 after the spring mechanism 15 has been wound up over for example 90° or more. By inserting these pins 60, 61 in each of the first actuation member 13 and the second actuation member 14 and releasing the spring mechanism 15 the actuation members 13, 14 will rotate with respect to each in said second mutual direction 18. This rotation will cause the pins 60, 61 to hit the supporting frame 19 and thereby prevent further relaxation of the spring mechanism 15. In this way, the torque storing mechanism 11 has a pre-determined amount of torque stored when the closing device 1 is mounted on the closure system 2 and the closure system 2 is closed. Each of these pins 60 and 61 are provided in the respective slot in the housing so that they can rotate therein when the closure member is opened and closed. Furthermore, the closing pressure of the closure member 3 can be adjusted based on the amount of torque stored in the spring mechanism 11. Moreover, even in the closed position, the spring mechanism 11 still urges the closure system 2 to a closed position thereby ensuring that the closure system 2 stays closed.

In the embodiment illustrated in the drawings, the mechanical connector piece 20 comprises at least one coupling mechanism 62 to attach the mechanical connector piece 20 to said second hinge member 7. In this way, the rotation of the second hinge member 7 due to opening or closing the closure system 2 is transmitted to the mechanical connector piece 20 which is mounted on the supporting frame 19 of the closing device 1. The mechanical connector piece 20 further transmits the rotation to the torque storing mechanism 11 and the damper mechanism 12 which is coupled thereto.

Preferably, the closing device 1 is arranged to be mounted on a closure system 2 wherein the second hinge member 7 comprises a threaded rod portion 9. The coupling mechanism 62 comprises a hole 63 in the mechanical connector piece 20 and a nut 66 provided for being mounted on said threaded rod portion 9 of the second hinge member 7. To transmit the rotation of the second hinge member 7, due to opening and closing the closure system 2, to the mechanical connector piece 20 two opposite lateral surfaces 67, 68 of said nut 66 and two opposing side walls 64, 65 of said hole 63 engage one another. Between the lateral surfaces of the nut and the opposing side walls of the hole there is only a minimal play to prevent the free extremity of the closure member 3, which may be a quite large gate, from moving freely over a too large distance.

In case the rotation axis 16 of the mechanical connector piece 20 does not coincides with the pivot axis 8, which will usually be the case, the nut 66 rotates over a small angle in the hole 63 in the mechanical connector piece 20 when the closure member is opened and closed. To prevent the closure member from rotating freely over a too large angle, the play of the nut 66 in the hole 63 should preferably remain substantially constant upon rotation of the nut in this hole.

In one embodiment, which has not been illustrated in the drawings, this can be achieved by curving the two opposing surfaces 67, 68 of said nut 66 such that these two opposing surfaces 67, 68 remain in contact with the two opposing side walls 64, 65 of the hole 63 in the mechanical connector piece 20. In this way, when the pivot axis 8 and the rotation axis 16 do not coincide the difference in rotation axis between the mechanical connector piece 20 and the second hinge member 7 is countered by the curved sides 67, 68 of the nut 66. In particular, when the pivot axis 7 and the rotation axis 16 do not coincide there will be both a translational and a rotational movement of the nut 66 with respect to the hole 63 in the mechanical connector piece 20. The mechanical connector piece 20 can be made thick enough at the location of the hole 63 so that the translational movement of the nut 66 is smaller than the thickness of the mechanical connector piece 20. Furthermore, the curved surfaces 67, 68 of the nut 66 can counter the rotational movement of the nut 66 with respect to the hole 63 in the mechanical connector piece 20. This can easily be achieved by shaping the curved sides 67, 68 in accordance with a cylinder oriented along the pivot axis 7. In this way, the distance between the contact points of the curved sides 67, 68 of the nut 66 with the flat sides 64, 65 of the hole 63 in the mechanical connector piece 20 is indeed always constant. Thus, there is some tolerance in mounting the closing device 1 on the closure system 2 since the pivot axis 7 and the rotation axis 16 do not have to coincide. This is especially also important since, in practice, hinges are available in different sizes so that the distance between the hinge axis 8 and the support 5 varies.

Instead of curving the lateral surfaces of the nut 66, the opposing side walls 64, 65 of the hole 63 are preferably curved (see FIG. 9) so that during opening and closing of the closure system 2 these two opposing side walls 64, 65 remain in contact with the second hinge member 7. In this way, the thickness of the mechanical connector piece 20 is not important since the straight nut 66 on the second hinge member 7 can be made longer than the translational movement between the mechanical connector piece 20 and the second hinge member 7. Moreover, although preferred, there is no need to provide a nut on the second hinge member 7 when this hinge member 7 itself provides the required surfaces to engage the opposing side walls 64, 65 of the hole 63 in the mechanical connector piece 20. However, in view of the fact that the closing device 1 should preferably be applicable in retrofit applications, a nut 66 is preferably applied so that the nut on the second hinge member 7 fits always correctly in the hole 63 in the mechanical connector piece 20.

The closing device according to the present invention is in particular suited for being retrofitted onto a closure system 2 which comprises, as illustrated for example in FIG. 7, a closure member 3 hinged by means of at least one hinge 4 onto a support 5. The hinge 4 comprises a first hinge member 6 fixed to the support 5 and a second hinge member 7 pivoted onto the first hinge member 6 around a pivot axis 8 and fixed to the closure member 3. The second hinge member 7 comprises a threaded rod portion 9 which enables to adjust the distance between the closure member 3 and the support 5. The closure system 2 is further provided with the closing device 1 according to the present invention mounted on the support 5 adjacent to the hinge 4 with the rotation axis 16 of the mechanical connector piece 20 oriented substantially parallel to said pivot axis 8. Furthermore, the mechanical connector piece 20 is mounted on the extremity of the supporting frame 19 nearest to the hinge 7. Moreover, the closure member 3 is adjustable in height with respect to the support 5 using a height adjust mechanism 10 as described in EP 1 528 202. Due to the fact that the closing device of the present invention acts upon the second hinge member 7, the height of the closure member 3 can always be adjusted without having to adjust the closure device.

A further important advantage is that the closure device can be mounted underneath the hinge 4 so that there is always sufficient space for the closing device. A closing device with a rotating arm can also be mounted underneath the hinge, but such a mounting position often requires a hinging arm to be able to connect the arm to the lateral bar of the gate. Such a hinging arm forms a scissor mechanism which can cause dangerous situations when the closing device is not mounted sufficiently high onto the support.

Although the present invention has been described with reference to specific exemplary embodiments, it will be evident that various modifications and changes may be made to these embodiments without departing from the broader scope of the invention as set forth in the claims. Accordingly, the description and drawings are to be regarded in an illustrative sense rather than a restrictive sense.

1. A device for closing a closure member of a closure system which comprises said closure member hinged by means of at least one hinge onto a support, which hinge comprises a first hinge member fixed to one of the closure member and the support and a second hinge member pivoted onto the first hinge member around a pivot axis and being fixed to the other one of the closure member and the support, the second hinge member comprising preferably a threaded rod portion which enables to adjust the distance between the closure member and the support,
which closing device is configured for being mounted on said closure system adjacent to said hinge and comprises a torque storing mechanism and a damper mechanism, which torque storing mechanism is arranged for storing torque when said closure member is being opened and for restoring said torque to effect closure of said closure member, and which damper mechanism is arranged for damping the closing movement of said closure member,
the torque storing mechanism comprising a first and a second actuation member and a spring mechanism arranged between both actuation members, the actuation members being rotatable with respect to one another around a rotation axis in a first mutual direction to store said torque in said spring mechanism and in a second mutual direction, which is opposite to said first mutual direction, to restore said torque, and
the damper mechanism being operatively coupled to the torque storing mechanism for damping the rotation of the first actuation member with respect to the second actuation member in said second mutual direction,
wherein
the closing device comprises further:
a frame supporting the damper mechanism and the torque storing mechanism, with both the first and the second actuation member being rotatable around said rotation axis with respect to the supporting frame, and with the supporting frame being configured to be mounted on the closure system with said rotation axis oriented substantially parallel to said pivot axis;
a mechanical connector piece which is rotatable with respect to the supporting frame around said rotation axis and which is configured for being mechanically fixed to said second hinge member;
a first locking mechanism enabling to lock the mechanical connector piece either with respect to said first or with respect to said second actuation member of the torque storing mechanism; and
a second locking mechanism enabling to lock the supporting frame with respect to said second actuation member when the connector piece is locked with respect to said first actuation member and with respect to said first actuation member when the connector piece is locked with respect to said second actuation member.

2. The closing device according to claim 1, wherein the first locking mechanism comprises a transverse connector element provided for locking the mechanical connector piece to either one of said first or said second actuation member and in that the second locking mechanism comprises a further transverse connector element provided for locking the other one of said first or said second actuation member to said supporting frame.

3. The closing device according to claim 2, wherein the mechanical connector piece has at least two openings provided for inserting said transverse connector element, wherein a first of said at least two openings is provided for locking the mechanical connector piece by means of said transverse connector element to said first actuation member and a second of said at least two openings is provided for locking the mechanical connector piece by means of said transverse connector element to said second actuation member.

4. The closing device according to claim 2, wherein each of the first and the second actuation members each have a first and a second receptor element, the first receptor element being provided for receiving said transverse connector element whilst the second receptor element is provided for receiving said further transverse connector element, wherein when the transverse connector element is inserted in the first receptor element in the first actuation member the further transverse connector element is inserted in the second receptor element in the second actuation member and vice versa when the further transverse connector element is inserted in the second receptor element in the first actuation member the transverse connector element is inserted in the first receptor element in the second actuation member.

5. The closing device according to claim 2, wherein each of the first and the second actuation members have a further receptor element provided for receiving a tool for rotating the first or the second actuation member in said first mutual direction.

6. The closing device according to claim 2, wherein the supporting frame comprises a housing which substantially encloses the torque storing mechanism and the damper mechanism, wherein the housing comprises at least two slots for receiving said transverse connector element and for enabling the actuation member which is connected to the mechanical connector piece to rotate around said rotation axis with the transverse connector element traveling through the slot.

7. The closing device according to claim 1, wherein the spring mechanism is a torsion spring which is coiled around said rotation axis and which has one extremity attached to the first actuating member and the other extremity attached to the second actuating member.

8. The closing device according to claim 1, wherein the damper mechanism is a hydraulic damper mechanism comprising:
a hydraulic cylinder barrel connected to the first actuation member and rotatably mounted with respect to said supporting frame around said rotation axis;
a damper shaft connected to the second actuation member and rotatably mounted with respect to said cylinder barrel around said rotation axis;
a piston placed inside the cylinder barrel dividing the cylinder barrel into two compartments;
a motion converting mechanism for converting a rotational motion of the damper shaft with respect to said cylinder barrel into a translational motion of the piston along said rotation axis;
at least one restricted fluid passage between the two compartments; and
at least one one-way valve allowing fluid flow between the two compartments when the first actuation member is rotating with respect to the second actuation member in said first mutual direction.

9. The closing device according to claim 1, wherein the mechanical connector piece is mounted on the supporting frame using at least one roller bearing, the mechanical connector piece being preferably mounted on an extremity of the supporting frame.

10. The closing device according to claim 1, wherein the mechanical connector piece comprises at least one coupling mechanism to attach the mechanical connector piece to said second hinge member.

11. The closing device according to claim 10, wherein said coupling mechanism comprises a hole in the mechanical connector piece, which hole has two opposing side walls which are arranged to transmit the rotation of said second hinge member to said mechanical connector piece and vice versa and which are curved so that when the mechanical connector piece rotates around said rotation axis and the second hinge member around said pivot axis, the two opposing side walls remain in contact, with no play or with a substantially constant play, with said second hinge member or with a nut screwed thereon also when said rotation axis does not coincide with said pivot axis.

12. The closing device according to claim 10, wherein said second hinge member comprises a threaded rod portion and in that said coupling mechanism comprises a hole in the mechanical connector piece and a nut provided for being screwed on said threaded rod portion of the second hinge member and wherein said nut has two opposite lateral surfaces and said hole two opposing side walls which are arranged to engages said lateral surfaces to transmit the rotation of said second hinge member to said mechanical connector piece and vice versa, the two opposite lateral surfaces of said nut being curved so that when the mechanical connector piece rotates around said rotation axis and the second hinge member around said pivot axis, the two opposite lateral surfaces of said nut remain in contact, with no play or with a substantially constant play, with said two opposing side walls of said hole in the mechanical connector piece also when said rotation axis does not coincide with said pivot axis.

13. A closure system which comprises a closure member hinged by means of at least one hinge onto a support, which hinge comprises a first hinge member fixed to one of the closure member and the support and a second hinge member pivoted onto the first hinge member around a pivot axis and being fixed to the other one of the closure member and the support, the second hinge member comprising preferably a threaded rod portion which enables to adjust the distance between the closure member and the support, wherein a closing device according to claim 1 is mounted on said closure system adjacent to said hinge with said rotation axis oriented substantially parallel to said pivot axis.

14. The closure system according to claim 13, wherein the mechanical connector piece of the closing device is mounted on an extremity of the supporting frame which is nearest to said hinge.

15. The closure system according to claim 13, wherein the closure member in the closure system is adjustable in height with respect to the support in the closure system.
